(19) United States
(12) Patent Application Publication
(10) Pub. No.: US 2024/0340606 A1
(43) Pub. Date: Oct. 10, 2024

(54) SPATIAL RENDERING OF AUDIO ELEMENTS HAVING AN EXTENT

(71) Applicant: Telefonaktiebolaget LM Ericsson (publ), Stockholm (SE)

(72) Inventors: Chamran MORADI ASHOUR, STOCKHOLM (SE); Tommy FALK, SPÅNGA (SE); Werner DE BRUIJN, STOCKHOLM (SE)

(73) Assignee: Telefonaktiebolaget LM Ericsson (publ), Stockholm (SE)

(21) Appl. No.: 18/700,065

(22) PCT Filed: Oct. 11, 2022
(86) PCT No.: PCT/EP2022/078174

§ 371 Date: Apr. 10, 2024

Related U.S. Application Data
(60) Provisional application No. 63/254,318, filed on Oct. 11, 2021.

(51) Int. Cl. H04S 7/00

(52) U.S. Cl. CPC H04S 7/303

(57) ABSTRACT

A method for rendering an audio element (e.g., a spatially-heterogeneous audio element), wherein the audio element has an extent and is represented using a set of virtual loudspeakers comprising a middle virtual loudspeaker. The method includes, based on a position of a listener, selecting a position for the middle virtual loudspeaker and/or calculating an attenuation factor for the middle virtual loudspeaker.

### TECHNICAL FIELD

Disclosed are embodiments related to rendering of audio elements.

### BACKGROUND

Spatial audio rendering is a process used for presenting audio within an extended reality (XR) scene (e.g., a virtual reality (VR), augmented reality (AR), or mixed reality (MR) scene) in order to give a listener the impression that sound is coming from physical sources within the scene at a certain position and having a certain size and shape (i.e., extent). The presentation can be made through headphone speakers or other speakers. If the presentation is made via headphone speakers, the processing used is called binaural rendering and uses spatial cues of human spatial hearing that make it possible to determine from which direction sounds are coming. The cues involve inter-aural time delay (ITD), inter-aural level difference (ILD), and/or spectral difference.

The most common form of spatial audio rendering is based on the concept of point-sources, where each sound source is defined to emanate sound from one specific point. Because each sound source is defined to emanate sound from one specific point, the sound source doesn't have any size or shape. In order to render a sound source having an extent (size and shape), different methods have been developed.

One such known method is to create multiple copies of a mono audio element at positions around the audio element. This arrangement creates the perception of a spatially homogeneous object with a certain size. This concept is used, for example, in the “object spread” and “object divergence” features of the MPEG-H 3D Audio standard (see references [1] and [2]), and in the “object divergence” feature of the EBU Audio Definition Model (ADM) standard (see reference [4]). This idea using a mono audio source has been developed further as described in reference [7], where the area-volumetric geometry of a sound object is projected onto a sphere around the listener and the sound is rendered to the listener using a pair of head-related (HR) filters that is evaluated as the integral of all HR filters covering the geometric projection of the object on the sphere. For a spherical volumetric source this integral has an analytical solution. For an arbitrary area-volumetric source geometry, however, the integral is evaluated by sampling the projected source surface on the sphere using what is called a Monte Carlo ray sampling.

Another rendering method renders a spatially diffuse component in addition to a mono audio signal, which creates the perception of a somewhat diffuse object that, in contrast to the original mono audio element, has no distinct pin-point location. This concept is used, for example, in the “object diffuseness” feature of the MPEG-H 3D Audio standard (see reference [3]) and the “object diffuseness” feature of the EBU ADM (see reference [5]).

Combinations of the above two methods are also known. For example, the “object extent” feature of the EBU ADM combines the creation of multiple copies of a mono audio element with the addition of diffuse components (see reference [6]).

In many cases the actual shape of an audio element can be described well enough with a basic shape (e.g., a sphere or a box). But sometimes the actual shape is more complicated and needs to be described in a more detailed form (e.g., a mesh structure or a parametric description format).

These methods, however, do not allow the rendering of audio elements that have a distinct spatially-heterogeneous character, i.e. an audio element that has a certain amount of spatial source variation within its spatial extent. Often these sources are made up of a sum of a multitude of sources (e.g., the sound of a forest or the sound of a cheering crowd). The majority of these known solutions are only able to create objects with either a spatially-homogeneous (i.e., with no spatial variation within the element), or a spatially diffuse character, which is too limited for rendering some of the examples given above in a convincing way.

In the case of heterogeneous audio elements, as are described in reference [8], the audio element comprises at least two audio channels (i.e., audio signals) to describe a spatial variation over its extent. Techniques exist for rendering these heterogeneous audio elements where the audio element is represented by a multi-channel audio recording and the rendering uses several virtual loudspeakers to represent the audio element and the spatial variation within it. By placing the virtual loudspeakers at positions that correspond to the extent of the audio element, an illusion of audio emanating from the audio element can be conveyed.

The number of virtual loudspeakers required to achieve a plausible spatial rendering of a spatially-heterogeneous audio element depends on the audio element's extent. For a spatially-heterogeneous audio element that is small or at some distance from the listener, a two-speaker setup might be enough. As illustrated in FIG. 1, however, for an audio element that is large and/or close to the listener, the two-speaker setup might be too sparse and cause a psychoacoustical hole in between the left speaker (SP-L) and the right speaker (SP-R) because the speakers are placed far apart. Adding a third center speaker will help to remedy this effect, which is why most standardized multi-channel speaker setups have a center speaker. The most straightforward way of rendering a spatially-heterogeneous audio element is by representing each of its audio channels as a virtual loudspeaker, but the number of loudspeakers can also be both lower and higher than the number of audio channels. If the number of virtual loudspeakers is lower than the number of audio channels, a down mixing step is needed to derive the signals for each virtual loudspeaker. If the number of virtual loudspeakers is higher than the number of audio channels, an up-mixing step is needed to derive the signals for each virtual loudspeaker. One implementation is to simply use two virtual loudspeakers at fixed positions.

### SUMMARY

Certain challenges presently exist. For example, rendering a spatially-heterogeneous audio element typically requires using a number of virtual loudspeakers. Using a large number of loudspeakers might be beneficial in order to have an evenly distributed audio representation of the extent, but, when source signal has a limited number of channels (e.g., a stereo signal) up-sampling to a large number of loudspeakers might cause problems where spatial quality is not increased with more loudspeakers. Also, using a large number of virtual loudspeakers results in undesirable high complexity. On the other hand, using too few virtual loudspeakers might harm the spatial characteristics of the audio elements so significantly that the rendering is no longer representing the corresponding audio element well. Therefore, choosing the number of virtual loudspeakers to render a spatially-heterogeneous audio element is a trade-off between complexity and quality.

The previously described problem of the psychoacoustical hole between two speakers is well known and is particularly a problem if the listener is not situated exactly in the sweet spot of the speakers. The typical multi-speaker setups designed for, for example, home theater use, are built around the assumption that the listener is situated somewhere around the sweet spot. In these systems, there is often a center speaker placed in the middle of the left and right front speakers, but, in the case of audio rendering for XR, when the listener can move around freely in six degrees of freedom, a static speaker setup will not be ideal. Especially if the listener moves close to the extent of the audio source, the problem with the psychoacoustical hole may be accentuated.

Thus, it is problematic to design a static loudspeaker setup that provides a good spatial representation with a limited number of loudspeakers that works for any listening position

Accordingly, in one aspect there is provided a method for rendering an audio element (e.g., a spatially-heterogeneous audio element), wherein the audio element has an extent and is represented using a set of virtual loudspeakers comprising a middle virtual loudspeaker. The method includes, based on a position of a listener, selecting a position for the middle virtual loudspeaker and/or calculating an attenuation factor for the middle virtual loudspeaker.

In another aspect there is provided a computer program comprising instructions which when executed by processing circuitry of an audio renderer causes the audio renderer to perform the above described method. In one embodiment, there is provided a carrier containing the computer program wherein the carrier is one of an electronic signal, an optical signal, a radio signal, and a computer readable storage medium. In another aspect there is provided a rendering apparatus that is configured to perform the above described method. The rendering apparatus may include memory and processing circuitry coupled to the memory.

An advantage of the embodiments disclosed herein is that they provide an adaptive method for placement of virtual loudspeakers for rendering a spatially-heterogeneous audio element having an extent. The embodiments enable adapting the position of a virtual loudspeaker, representing the middle of the extent, to the current listener position so that the spatial distribution over the extent is preserved using a small number of virtual loudspeakers. Compared to simpler methods that distribute speakers evenly over the extent of the audio element, the embodiments provide a more efficient solution that will work for all listening positions without using a large number of virtual loudspeakers.

### BRIEF DESCRIPTION OF THE DRAWINGS

The accompanying drawings, which are incorporated herein and form part of the specification, illustrate various embodiments.

FIG. 1 illustrates a psychoacoustical hole.

FIG. 2A illustrates an example virtual loud speaker setup.

FIG. 2B illustrates an example virtual loud speaker setup that may create a psychoacoustical hole.

FIG. 3 illustrates an example virtual loud speaker setup.

FIG. 4 illustrates an example virtual loud speaker setup where the middle speaker is placed close to an edge speaker.

FIG. 5 illustrates one embodiment of how the preferred position of the middle speaker can be determined.

FIG. 6 illustrates another embodiment of how the preferred position of the middle speaker can be determined.

FIG. 7 illustrates one embodiment of how the preferred position of the middle speaker can be determined when the audio element extent is a rectangular shape.

FIG. 8 is a flowchart illustrating a process according to some embodiments.

FIG. 9 is a flowchart illustrating a process according to some embodiments.

FIG. 10 is a flowchart illustrating a process according to some embodiments.

FIGS. 11A and 11B show a system according to some embodiments.

FIG. 12 illustrates a system according to some embodiments.

FIG. 13. illustrates a signal modifier according to an embodiment.

FIG. 14 is a block diagram of an apparatus according to some embodiments.

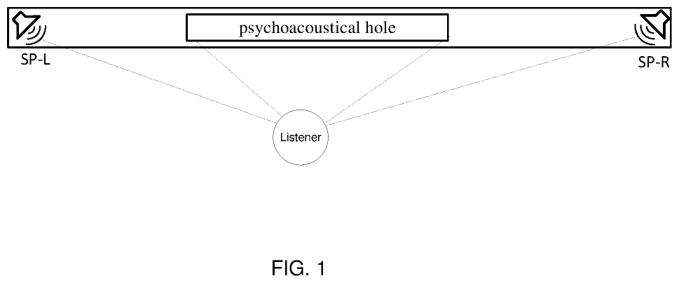

### DETAILED DESCRIPTION

This disclosure proposes, among other things, different ways to adapt the positions of a virtual loudspeaker (or “speaker” for short) used for representing an audio element having an extent (e.g., a spatially-heterogeneous audio element having a certain size and shape). By using a number of (e.g., two or more) speakers to represent outer edges of the audio element and using at least one speaker (hereafter “the middle speaker”) that is adaptively placed between the edges of the audio element or edges of a simplified shape representing the audio element, an optimized rendering can be achieved with a perceptually evenly distributed audio energy over the audio element's extent with a small number of speakers. Additionally, the potential problem of unwanted excessive energy resulting from the overlap of the extra middle speaker and one of the side speakers is addressed.

### Overview

An objective is to render an audio element having an extent so that the sound is perceived by the listener to be evenly distributed over the extent for any listening position. The embodiments use as few speakers as possible and avoids or reduces the problem of psychoacoustical holes.

In some embodiments, a set of speakers that represent the edges of the audio element and a middle speaker that is adaptively placed so that it represents the middle of the audio element is used to render the audio element, where the placement of the middle speaker and/or an attenuation factor (a.k.a., gain factor) for the middle speaker takes into account the listening position (e.g., the position of the listener in the virtual space with respect to the audio element).

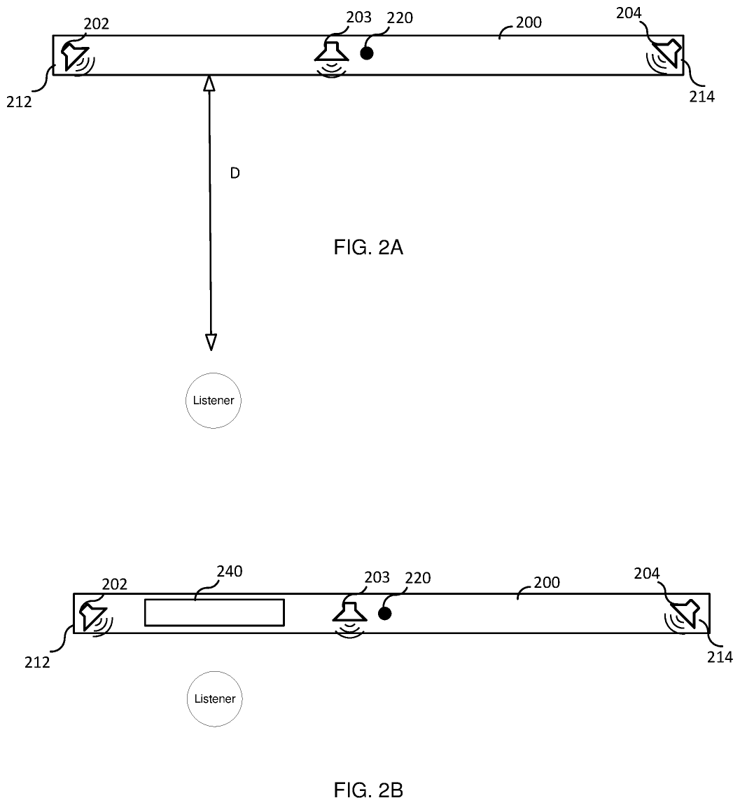

An example of such a rendering setup is shown in FIG. 2A, which shows an extent 200 that represents an audio element. The extent 200 that represents the audio element may be the extent of the audio element (i.e., the extent 200 has the same size and shape of the actual extent of the audio element) or it may be a simplified extent that is derived from the extent of the audio element (e.g., a line or a rectangle). International Patent application No. WO2021180820 describes different ways to generate such a simplified extent.

FIG. 2A further shows that a left speaker 202 is positioned at a left edge 212 point of the extent 200, a right speaker 204 is positioned at a right edge point 214 of the extent, and a middle speaker 203 is positioned somewhere in-between the left and right edge points.

Advantageously, in one embodiment, the positioning of the middle speaker 203 is controlled so that when the listener is at least some distance (D) from the audio element, the middle speaker 203 is placed at or close to the midpoint (MP) 220 between the first edge point and the second edge point of the extent because this will provide the most even spatial distribution over the extent. The distance D will typically depend on the size of extent 200.

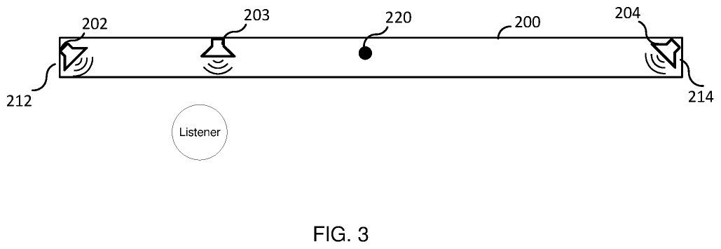

As illustrated in FIG. 2B, keeping the middle speaker 203 at or near the midpoint 220 when the listener moves close to the audio element, may lead to a problem with a psychoacoustical hole 240. Accordingly, in this situation, the middle speaker 203 will be moved to a new position, as shown in FIG. 3, so that an even spatial distribution is preserved.

### Adaptive Placement of the Middle Speaker

Some embodiments herein adaptively position the middle speaker 203 based on the position of the listener. In many situations, the aim is to position the middle speaker on a selected “anchor point” for the audio element, which anchor point may move with the listener. For example, in one embodiment, the anchor point is the point of extent 200 that is closest to the listener. But in other embodiments, the anchor point can be defined differently. International Patent application No. WO2021180820, describes different ways to select an anchor point for an audio element. There are, however, situations where it is not advantageous to position the middle speaker on the anchor point.

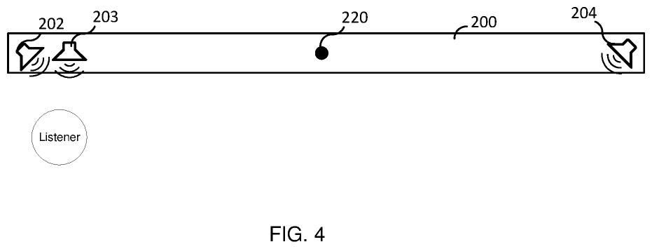

For example, when the listener is close to one of the edges of the audio element, if the middle speaker were placed on the anchor point, then the middle speaker and the corresponding side speaker would overlap and result in an undesirable increase of the energy from the corresponding side as is shown in FIG. 4. In this situation, it would be advantageous to position the middle speaker closer to the midpoint between the left and right edge points (e.g., the location of the left and right speakers) in order to have a more evenly distributed audio energy.

As another example, when the distance between the listener and the audio element is greater than a threshold (which threshold may be dependent on the extent of the audio element), experiments show that placing the middle speaker closer to midpoint 220 gives perceptually more relevant output.

In summary, positioning the middle speaker at the anchor point is usually preferred when the listener is close to the extent but not close to one of the edges of the extent; in the other listening positions, the preferred middle speaker position is at or near midpoint 220.

The proposed embodiments, therefore, provide for an adaptive placement of the middle speaker that optimizes the position depending on the current listening position.

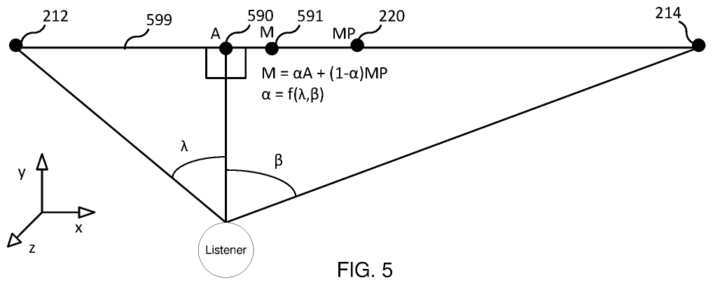

More specifically, in one embodiment, placing the middle speaker at the anchor point is avoided when the anchor position is close to one of the edge speakers. Accordingly, in addition to considering the anchor point (A) 590 (see FIG. 5), the positioning of the middle speaker 203 may also depend on the midpoint (MP) 220.

In one embodiment, the preferred position of middle speaker 203, denoted “M” 591, on a line 599, which goes from one edge point of extent 200 (e.g., left edge point 212) to another edge point of extent 200 (e.g., right edge point 214), is calculated using equation (1):

$$M = α * A + ( 1 - α ) * MP . \qquad ( Eq . 1 )$$

where A is the position of the anchor point on line 599, MP is the position of the midpoint on line 599, and α ∈ [0,1] is a factor that controls the weight of the anchor point and midpoint on positioning the middle speaker on line 599.

The value of a is such that when the listener is close to the extent and not close to the edges of the extent, M is near or on the anchor point (α→1), and when the listener is close to one the edges of the extent 200 or far from the extent, M is near or on the midpoint (α→0). Therefore, a takes, simultaneously, into account the movement of the listener in both x-direction and z-direction. Once the M point 591 is determined, middle speaker 203 can be “placed” at the M point. That is, the position of middle speaker 203 is set as the M point.

In one embodiment a is function of two variables: xm_w, and zm_w. That is:

$$α = f ( xm\_w , zm\_w ) . \qquad ( Eq . 2 )$$

The first variable, xm_w is a weight reflecting x-direction movement of the listener and zm_w is the weight reflecting z-direction movement of the listener. The parameters B and A, shown in FIG. 5, are used to set the value for xm_w and zm_w.

In one embodiment, xm_w is a function of λ and β—i.e.,

$$xm\_w = f 1 ( λ , β ) = \{ \begin{matrix}\frac{sin ( λ )}{sin ( β )} , & β > λ \\ \frac{sin ( β )}{sin ( λ )} , & λ > β\end{matrix} . \qquad ( Eq . 3 )$$

From the equation 3 and FIG. 5 it can be seen that with movement of the listener towards either of the edges of extent 200, then: λ→0 or β→0, and, therefore, xm_w→0. Likewise, when the listener moves towards the middle, then A and B approach each other and xm_w approaches 1.

Z-direction weight zm_w is also a function of λ and β—i.e.,

$$xm\_w = f 2 ( λ , β ) = sin ( ( λ + β ) / 2 ) . \qquad ( Eq . 4 )$$

From Eq. 4 and FIG. 5, it can be observed that the closer the listener gets to the extent the larger λ and β become, with λ+β approaching 180 degrees at very close distances to the extent, thus zm_w approaches 1, and the further the listener gets from the extent the smaller λ and β become thus zm_w approaches 0.

In one embodiment a is defined as:

$$α = f 3 ( xm\_w , zm\_w ) = min ( 1 , d * xm\_w * zm\_w ) \qquad ( Eq . 5 )$$

Where d ∈ (0, +∞) is a tuning factor that controls α factor. Experiments show d≈2.2 gives a desired result. The above derivation of α is just one way of using information representing the relative position of the listener to the extent. Any other way of using λ and β (e.g. cosine or tangent of λ and β) or any other parameters (e.g. coordinates of the listener and midpoint, anchor point, left edge and right edge of the extent) that can reflect the relative position of the listener to extent, can be used to derive α.

Another approach to deal with the excessive energy when the listener is on the edge of the audio element may be attenuation of the energy of the signal that is played back through the middle speaker instead of changing its position. That is, middle speaker 203 is positioned at the anchor point, but the audio signal for middle speaker 203 is attenuated when the listener approaches the edges of the audio element. To do so, the angles described in FIG. 5 can be used such that:

$${X}^{′} = \{ \begin{matrix}\frac{sin ( λ )}{sin ( β )} * X , & β > λ \\ \frac{sin ( β )}{sin ( λ )} * X , & λ > β\end{matrix} .$$

Where X is the original time domain audio signal for middle speaker 203 and X′ is the time domain signal played back by middle speaker 203. This approach mitigates the excessive energy problem but may not improve the spatial perception of the audio element.

### Adaptive Placement of the Middle Speaker Based on Equal Angles

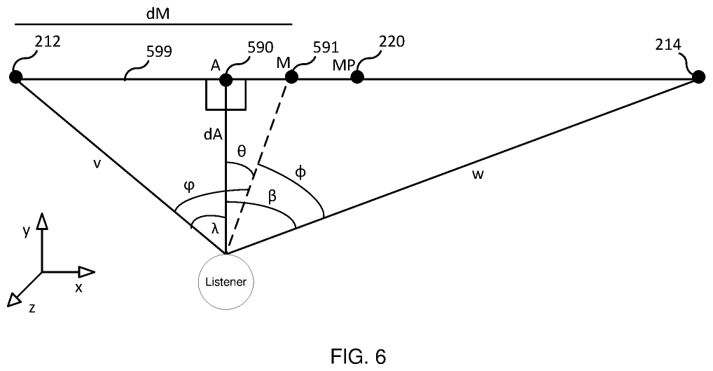

In another embodiment the placement of the middle speaker is controlled only by the angles to the left and right edge points. In FIG. 6 these angles are φ=λ+θ and ϕ=β−θ, respectively. In one embodiment, the M point 591 is selected such that ϕ=φ. If the distance (dA) between the listener and the anchor point is known, then the distance (dM) from M point 591 to point 212 can be determined by calculating: dM=dA*(tan (λ)+tan (θ)), and, hence the x-coordinate of the M point is equal to the x-coordinate of left edge point 212+dM.

If dA is not known, but v (the distance between the listener and left edge point 212) and w (the distance between the listener and right edge point 214) are known, then the location of the M point can be determined by calculating: M=(v*Re+w*Le)/(v+w), where Re is the x-coordinate of the right edge point 214 and Le is the x-coordinate of the left edge point 212.

### Adaptive Placement of the Middle Speaker in Two Dimensions

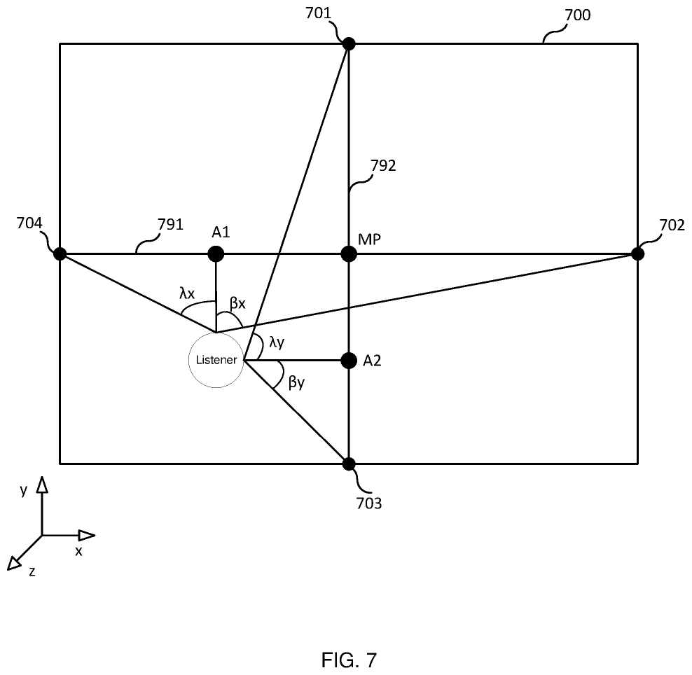

The examples provided above illustrate a one-dimensional audio element extent. The techniques described above also apply to a two-dimensional audio element extent, such as, for example, extent 700 shown in FIG. 7. In this example, extent 700 has a rectangular shape and four edge points are defined: a top edge point 701, a right edge point 702, a bottom edge point 703, and a left edge point 704. In this example, for each edge point, the edge point is located at the midpoint of the edge on which the edge point sits. Hence, left edge 704 point is then the position that is exactly in the center between the top-left and bottom-left corners of extent 700; right edge point 702 is exactly in the center between the top-right and bottom-right corners of extent 700; top edge point 701 is exactly in the center between the top-left and top-right corners of extent 700; and bottom edge point 703 is exactly in the center between the bottom-left and bottom-right corners of extent 700.

In one embodiment, for each defined edge point 701-704, a speaker can be positioned at the point. Hence, in one embodiment, four speakers are used to represent the top, bottom, left and right edges of this two-dimensional plane 700. In another embodiment, a speaker is positioned in each corner point of plane 700.

Additionally, a middle speaker can also be employed and it can be positioned using the same principles as already described. That is, the coordinates (Mx, My) for the middle speaker can be determined by calculating:

$$Mx = α x * A 1 x + ( 1 - α x ) * MPx ; and \\ My = α y * A 2 y + ( 1 - α y ) * MPy ,$$

where:
αx=f3 (xm_w, zm1_w), αy=f3 (ym_w,zm2_w), A1x is the x-coordinate of anchor point A1, A2y is the y-coordinate of anchor point A2, MPx is the x-coordinate of the midpoint, MPy is the y-coordinate of the midpoint, xm_w=f1 (λx,βx), ym_w=f1 (λy,βy), zm1_w=f2 (λx,βx), and zm2_w=f2 (λy,βy).

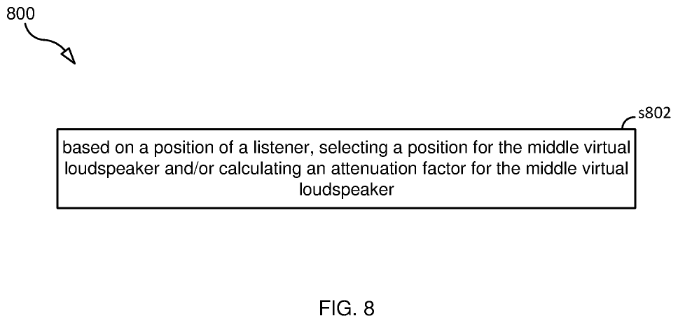

FIG. 8 is a flowchart illustrating a process 800, according to an embodiment, for rendering an audio element (e.g., a spatially-heterogeneous audio element), wherein the audio element has an extent and is represented using a set of virtual loudspeakers comprising a middle virtual loudspeaker. Process 800 may begin in step s802. Step s802 comprises, based on a position of a listener, selecting a position for the middle virtual loudspeaker and/or calculating an attenuation factor for the middle virtual loudspeaker.

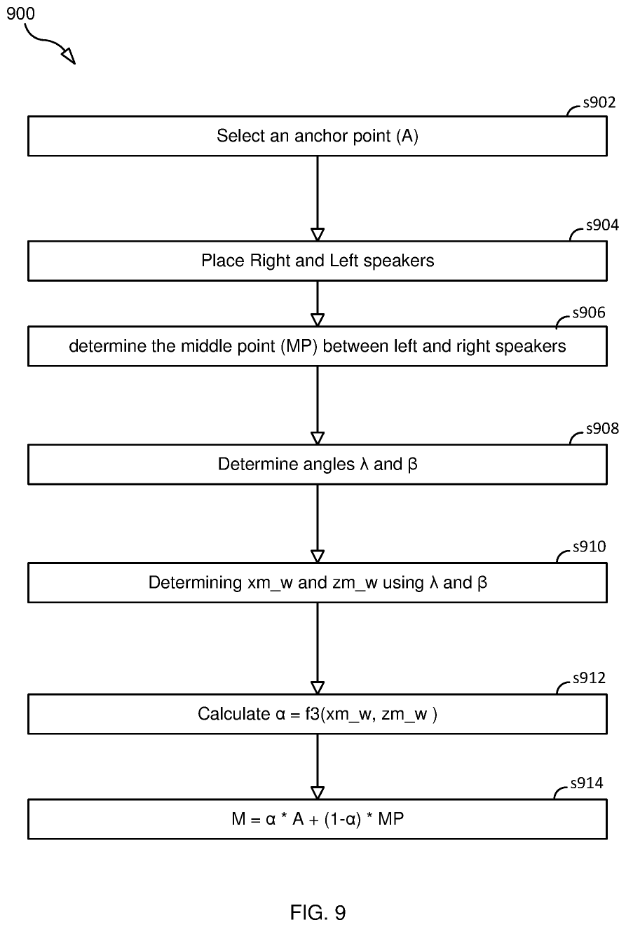

FIG. 9 is a flowchart illustrating a process 900, according to an embodiment, for rendering an audio element (e.g., a spatially-heterogeneous audio element), wherein the audio element has an extent and is represented using a set of virtual loudspeakers comprising a middle virtual loudspeaker. Process 900 may begin in step s902.

Step s902 comprises selecting an anchor point for the audio element. Typically the anchor point is on the straight line that passes through a first edge point of an extent associated with the audio element (e.g., the audio elements actual extent or a simplified extent for the audio element) and a second edge point of the extent and the anchor point is dependent on the location of the listener. In some embodiments where the audio element has a complex extent, selecting the anchor point is part of a process for creating a simplified extent for the audio element based on the listener position and the audio element's extent.

Step s904 comprises placing a first speaker (e.g., a right speaker) and placing a second speaker (e.g., a left speaker). That is, a position for the first and second speakers is determined. In one embodiment, the speakers are positioned on opposite edges of the extent. That is, a left speaker is positioned on a left edge point of the extent and the right speaker is positioned on a right edge point of the extent. In an embodiment where the extent associated with the audio element is rectangle, a speaker is placed in each corner of the rectangle.

Step s906 comprises determining the midpoint between the two speakers.

Step s908 comprises determine a first angle (λ) between a straight line from the listener to the anchor point and the straight line from the listener to the left speaker, and a second angle (B) between a straight line from the listener to the anchor point and the straight line from the listener to the right speaker (an example of λ and β is shown in FIG. 5).

Step s910 comprises determining an x-weight value (xm_w) and a z-weight value (zm_w) (e.g., calculating xm_w=f1 (λ,β) and zm_w=f2 (λ,β)).

Step s912 comprises determining α factor (α) based on xm_w and zm_w. That is α is a function of xm_w and zm_w (e.g., α=f3 (xm_w, zm_w)).

Step s914 comprises calculating M=α*A+(1−α)*MP, where M is an x-coordinate of the preferred position of the middle speaker, A is the x-coordinate of the Anchor point, and MP is the x-coordinate of the midpoint between the left and right speakers.

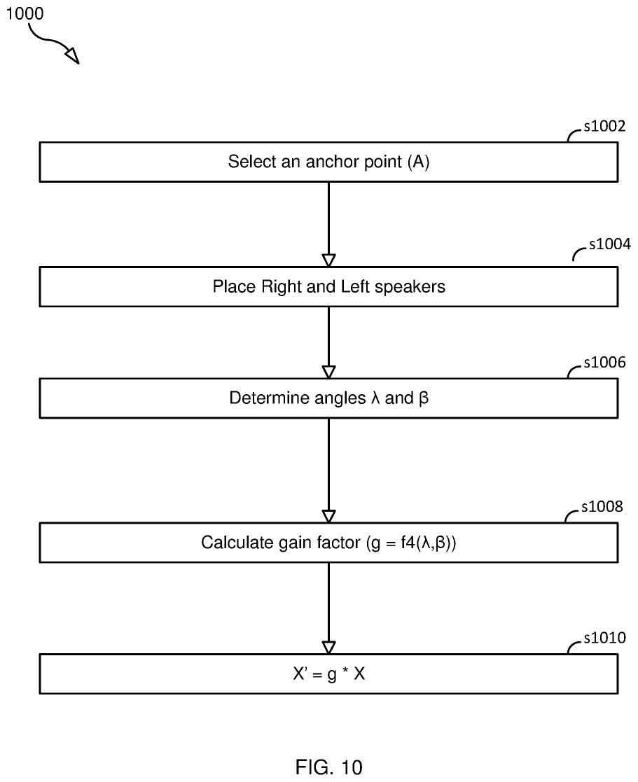

FIG. 10 is a flowchart illustrating a process 1000, according to an embodiment, for rendering an audio element (e.g., a spatially-heterogeneous audio element), wherein the audio element has an extent and is represented using a set of virtual loudspeakers comprising a middle virtual loudspeaker. Process 1000 may begin in step s1002.

Step s1002 comprises selecting an anchor point for the audio element (see step s902 above).

Step s1004 comprises placing a first speaker (e.g., a right speaker) and placing a second speaker (e.g., a left speaker). That is, a position for the first and second speakers is determined (see step s904 above).

Step s1006 comprises determining a first angle (λ) between a straight line from the listener to the anchor point and the straight line from the listener to the left speaker, and a second angle (β) between a straight line from the listener to the anchor point and the straight line from the listener to the right speaker (an example of λ and β is shown in FIG. 5).

Step s1008 comprises calculating a gain factor (g) using λ and β. For example, g=f4 (λ, β).

Step s1010 comprises processing a signal (X) for the middle speaker using the gain factor (g) to produce a modified signal X′. For example, X′=g*X.

### Example Use Case

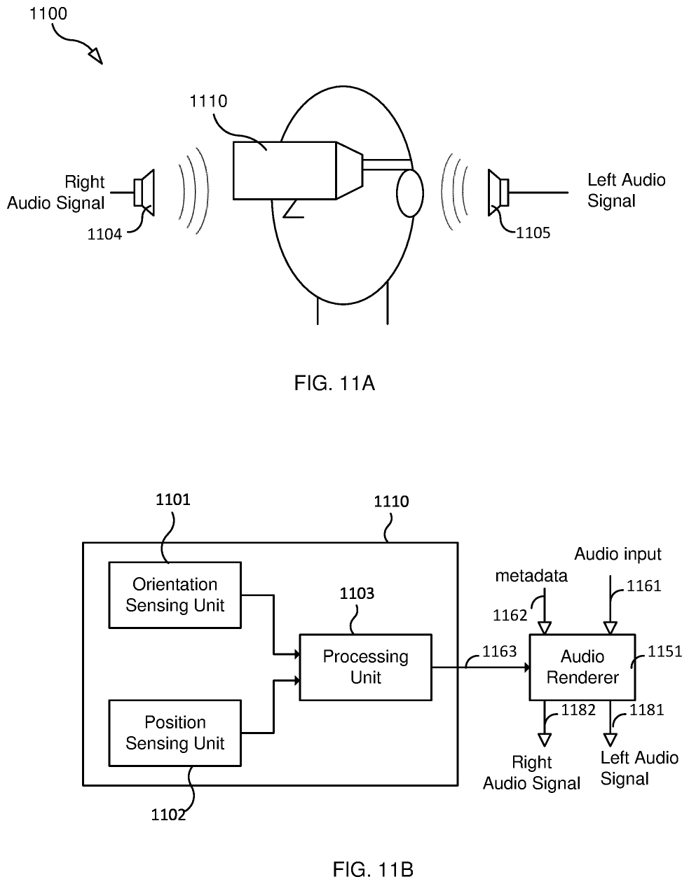

FIG. 11A illustrates an XR system 1100 in which the embodiments disclosed herein may be applied. XR system 1100 includes speakers 1104 and 1105 (which may be speakers of headphones worn by the listener) and an XR device 1110 that may include a display for displaying images to the user and that, in some embodiments, is configured to be worn by the listener. In the illustrated XR system 1100, XR device 1110 has a display and is designed to be worn on the user's head and is commonly referred to as a head-mounted display (HMD).

As shown in FIG. 11B, XR device 1110 may comprise an orientation sensing unit 1101, a position sensing unit 1102, and a processing unit 1103 coupled (directly or indirectly) to an audio render 1151 for producing output audio signals (e.g., a left audio signal 1181 for a left speaker and a right audio signal 1182 for a right speaker as shown).

Orientation sensing unit 1101 is configured to detect a change in the orientation of the listener and provides information regarding the detected change to processing unit 1103. In some embodiments, processing unit 1103 determines the absolute orientation (in relation to some coordinate system) given the detected change in orientation detected by orientation sensing unit 1101. There could also be different systems for determination of orientation and position, e.g. a system using lighthouse trackers (lidar). In one embodiment, orientation sensing unit 1101 may determine the absolute orientation (in relation to some coordinate system) given the detected change in orientation. In this case the processing unit 1103 may simply multiplex the absolute orientation data from orientation sensing unit 1101 and positional data from position sensing unit 1102. In some embodiments, orientation sensing unit 1101 may comprise one or more accelerometers and/or one or more gyroscopes.

Audio renderer 1151 produces the audio output signals based on input audio signals 1161, metadata 1162 regarding the XR scene the listener is experiencing, and information 1163 about the location and orientation of the listener. The metadata 1162 for the XR scene may include metadata for each object and audio element included in the XR scene, and the metadata for an object may include information about the dimensions of the object. The metadata 1162 may also include control information, such as a reverberation time value, a reverberation level value, and/or an absorption parameter. Audio renderer 1151 may be a component of XR device 1110 or it may be remote from the XR device 1110 (e.g., audio renderer 1151, or components thereof, may be implemented in the so called “cloud”).

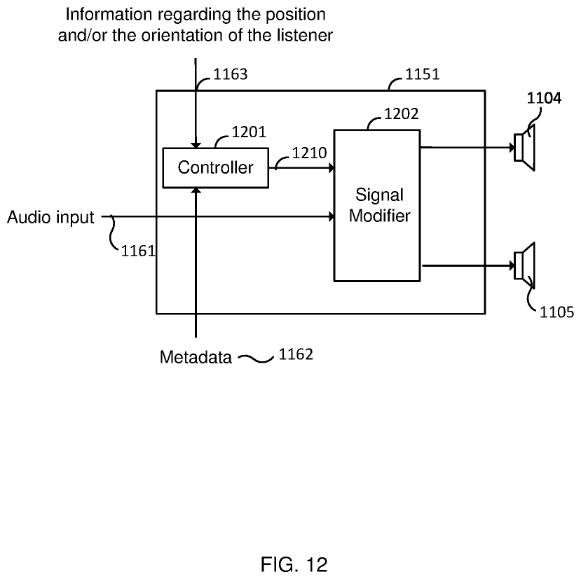

FIG. 12 shows an example implementation of audio renderer 1151 for producing sound for the XR scene. Audio renderer 1151 includes a controller 1201 and a signal modifier 1202 for modifying audio signal(s) 1161 (e.g., the audio signals of a multi-channel audio element) based on control information 1210 from controller 1201. Controller 1201 may be configured to receive one or more parameters and to trigger modifier 1202 to perform modifications on audio signals 1161 based on the received parameters (e.g., increasing or decreasing the volume level). The received parameters include information 1163 regarding the position and/or orientation of the listener (e.g., direction and distance to an audio element) and metadata 1162 regarding an audio element in the XR scene (e.g., extent 200) (in some embodiments, controller 1201 itself produces the metadata 1162). Using the metadata and position/orientation information, controller 1201 may calculate one more gain factors (g) (a.k.a., attenuation factors) for an audio element in the XR scene as described herein.

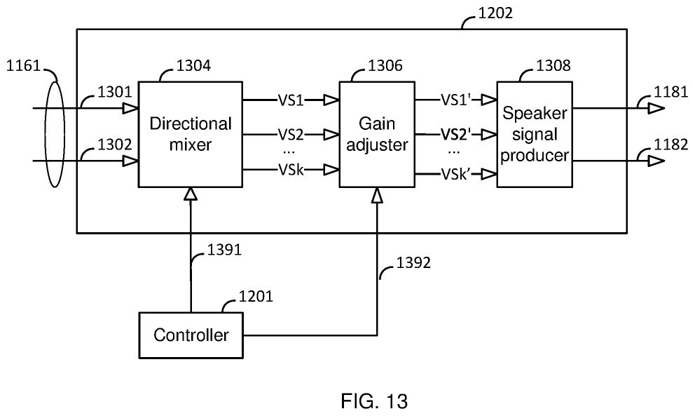

FIG. 13 shows an example implementation of signal modifier 1202 according one embodiment. Signal modifier 1202 includes a directional mixer 1304, a gain adjuster 1306, and a speaker signal producer 1308.

Directional mixer receives audio input 1161, which in this example includes a pair of audio signals 1301 and 1302 associated with an audio element (e.g. the audio element associated with extent 200 or 700), and produces a set of k virtual loudspeaker signals (VS1, VS2, . . . , VSk) based on the audio input and control information 1391. In one embodiment, the signal for each virtual loudspeaker can be derived by, for example, the appropriate mixing of the signals that comprise the audio input 1161. For example: VS1=α×L+β×R, where L is input audio signal 1301, R is input audio signal 1302, and α and β are factors that are dependent on, for example, the position of the listener relative to the audio element and the position of the virtual loudspeaker to which VS1 corresponds.

Gain adjuster 1306 may adjust the gain of any one or more of the virtual loudspeaker signals based on control information 1392, which may include the above described gain factors as calculated by controller 1301. That is, for example, when the middle speaker 203 is placed close to another speaker (e.g., left speaker 202 as shown in FIG. 4), controller 1301 may control gain adjuster 1306 to adjust the gain of the virtual loudspeaker signal for middle speaker 203 by providing to gain adjuster 1306 a gain factor calculated as described above.

Using virtual loudspeaker signals VS1, VS2, . . . , VSk, speaker signal producer 1308 produces output signals (e.g., output signal 1181 and output signal 1182) for driving speakers (e.g., headphone speakers or other speakers). In one embodiment where the speakers are headphone speakers, speaker signal producer 1308 may perform conventional binaural rendering to produce the output signals. In embodiments where the speakers are not headphone speakers, speaker signal produce may perform conventional speaking panning to produce the output signals.

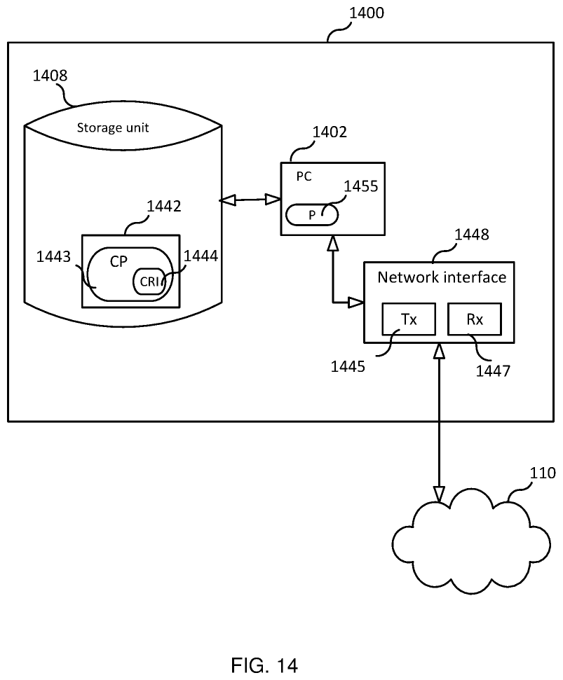

FIG. 14 is a block diagram of an audio rendering apparatus 1400, according to some embodiments, for performing the methods disclosed herein (e.g., audio renderer 1151 may be implemented using audio rendering apparatus 1400). As shown in FIG. 14, audio rendering apparatus 1400 may comprise: processing circuitry (PC) 1402, which may include one or more processors (P) 1455 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1400 may be a distributed computing apparatus); at least one network interface 1448 comprising a transmitter (Tx) 1445 and a receiver (Rx) 1447 for enabling apparatus 1400 to transmit data to and receive data from other nodes connected to a network 110 (e.g., an Internet Protocol (IP) network) to which network interface 1448 is connected (directly or indirectly) (e.g., network interface 1448 may be wirelessly connected to the network 110, in which case network interface 1448 is connected to an antenna arrangement); and a storage unit (a.k.a., “data storage system”) 1408, which may include one or more non-volatile storage devices and/or one or more volatile storage devices. In embodiments where PC 1402 includes a programmable processor, a computer readable medium (CRM) 1442 may be provided. CRM 1442 stores a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes audio rendering apparatus 1400 to perform steps described herein (e.g., steps described herein with reference to the flow charts). In other embodiments, audio rendering apparatus 1400 may be configured to perform steps described herein without the need for code. That is, for example, PC 1402 may consist merely of one or more ASICs. Hence, the features of the embodiments described herein may be implemented in hardware and/or software.

### Summary of Various Embodiments

A1. A method for rendering an audio element (e.g., a spatially-heterogeneous audio element), wherein the audio element has an extent and is represented using a set of virtual loudspeakers comprising a middle virtual loudspeaker, the method comprising: based on a position of a listener, selecting a position for the middle virtual loudspeaker and/or calculating an attenuation factor for the middle virtual loudspeaker.
A2. The method of embodiment A1, wherein the method comprises selecting the position for the middle virtual loudspeaker based on the position of the listener, and selecting the position for the middle virtual loudspeaker based on the position of the listener comprises: determining a first angle based on the position of the listener and a position of i) a first edge point of the audio element or of an extent that was determined based on the extent of the audio element or ii) a first virtual loudspeaker; determining a second angle based on the position of the listener and a position of i) a second edge point of the audio element or of the extent or ii) a second virtual loudspeaker; and calculating a first coordinate, Mx, for the middle virtual loudspeaker using the first angle and the second angle, wherein the selected position for the middle virtual loudspeaker is specified at least partly by the calculated first coordinate.
A3. The method of embodiment A2, wherein selecting the position for the middle virtual loudspeaker based on the position of the listener further comprises: determining a third angle based on the position of the listener and a i) position of a third edge point of the audio element or of the extent or ii) a third virtual loudspeaker; determining a fourth angle based on the position of the listener and a position of i) a fourth edge point of the audio element or of the extent or ii) a fourth virtual loudspeaker; and calculating a second coordinate, My, for the middle virtual loudspeaker using the third angle and the fourth angle, wherein the selected position is specified at least partly by the calculated first and second coordinates.
A4. The method of embodiment A2 or A3, wherein calculating the first coordinate, Mx, for the middle virtual loudspeaker using the first angle and the second angle comprises: determining a first factor, α1, using the first and second angles; and calculating: Mx= (α1*Ax)+((1−α1)*MPx), where Ax is a coordinate used in specifying a location of a determined anchor point on a straight line extending between the first edge point and the second edge point (or between the first and second virtual loudspeakers), and MPx is a coordinate used in specifying the midpoint of the straight line.
A5. The method of embodiment A4, wherein determining α1 using the first and second angles comprises: calculating a first weight, xm_w, using the first and second angles, calculating a second weight, zm_w, using the first and second angles, and determining α1 based on xm_w and zm_w.
A6. The method of embodiment A5, wherein determining α1 based on xm_w and zm_w comprises: determining whether d*xm_w*zm_w is less than 1, where d is a predetermined factor; and setting α1 equal to 1 if d*xm_w*zm_w is not less than 1, otherwise setting α1 equal to d*xm_w*zm_w.
A7. The method of embodiment A5 or A6, wherein calculating xm_w using the first and second angles comprises calculating: xm_w=sin (λ)/sin (β) or xm_w=sin (β)/sin (λ), where λ is the first angle and β is the second angle.
A8. The method of embodiment A5, A6 or A7, wherein calculating zm_w using the first and second angles comprises calculating: zm_w=sin ((λ+β)/2).
A9. The method of embodiment A3, wherein calculating the second coordinate, My, for the middle virtual loudspeaker using the third angle and the fourth angle comprises: determining a second factor, α2, using the third and fourth angles; and calculating: My=(α2*Ay)+((1−α2)*MPy), where Ay is a coordinate used in specifying a location of a determined anchor point on a straight line extending between the third edge point and the fourth edge point (or between the third and fourth virtual loudspeakers), and MPy is a coordinate used in specifying the midpoint of the straight line.
A10. The method of embodiment A1, wherein the method comprises selecting the position for the middle virtual loudspeaker based on the position of the listener, and selecting the position for the middle virtual loudspeaker based on the position of the listener comprises: selecting a position point on a first straight line 1) between a first point (e.g., first edge point) of the audio element or of an extent that was determined based on the extent of the audio element and a second point (e.g., second edge point) of the audio element or of the extent or 2) between a first virtual speaker and a second virtual speaker, such that: the angle between i) a second straight line running from the position of the listener to the first point (or first virtual speaker) and ii) a third straight line running from the position of the listener to the selected position point on the first straight line is equal to the angle between i) a fourth straight line running from the position of the listener to the second point (or to the second virtual loudspeaker) and ii) the third straight line.
A11. The method of embodiment A10, wherein selecting the position point comprises calculating a coordinate, M, of the position point by calculating: M=(v*Re+w*Le)/(v+w), where v is the length of the second straight line, w is the length of the third straight line, Re is a coordinate of the first point or first virtual speaker, and Le is a coordinate of the second point or second virtual speaker.
A12. The method of embodiment A10 or A11, further comprising positioning the middle virtual loudspeaker at the selected position point.
A13. The method of any one of embodiments A1-A12, wherein the method comprises calculating an attenuation factor for the middle virtual loudspeaker based on the position of the listener, and calculating the attenuation factor for the middle virtual loudspeaker based on the position of the listener comprises: determining a first angle based on the position of the listener and i) a position of a first edge point of the audio element or of an extent that was determined based on the extent of the audio element or ii) a position of a first virtual loudspeaker; determining a second angle based on the position of the listener and i) a position of a second edge point of the audio element or of the extent or ii) a position of a second virtual loudspeaker; and calculating ε=sin (λ)/sin (β) or ε=sin (β)/sin (λ), where λ is the first angle, β is the second angle, and ε is the attenuation factor.
A14. The method of embodiment A13, further comprising modifying a signal, X, for the middle virtual loudspeaker to produce a modified middle virtual loudspeaker signal, X′, such that X′=ε*X, and using the modified middle virtual loudspeaker signal to render the audio element (e.g., generate an output signal using the middle virtual loudspeaker signal).
A15. The method of any one of embodiments A2-A14, wherein the set of virtual loudspeakers further comprises: a first virtual loudspeaker positioned at the first edge point and a second virtual loudspeaker positioned at the second edge point, and the method further comprises using information identifying the positions of the virtual loudspeakers to render the audio element.
A16. The method of embodiment A3 or A9, wherein the set of virtual loudspeakers further comprises: a first virtual loudspeaker positioned at the first edge point (e.g., a first corner point, or a first point that is the midpoint between a first pair of corner points), a second virtual loudspeaker positioned at the second edge point (e.g., a second corner point, or a second point that is the midpoint between another pair of corner points), a third virtual loudspeaker positioned at the third edge point (e.g., a third corner point, or a third point that is the midpoint between another pair of corner points), and a fourth virtual loudspeaker positioned at the fourth edge point (e.g., a fourth corner point, or a fourth point that is the midpoint between another pair of corner points), and the method further comprises using information identifying the positions of the virtual loudspeakers to render the audio element.
A17. The method of embodiment A1, wherein the method comprises selecting the position for the middle virtual loudspeaker based on the position of the listener, and selecting the position for the middle virtual loudspeaker based on the position of the listener comprises: determining a distance from the position of the listener to a position of the audio element; determining whether the determined distance is greater than a threshold; and as a result of determining that the determined distance is greater than the threshold, selecting a position at a midpoint of the audio element or of an extent that was determined based on the extent of the audio element.
A18. The method of embodiment A1, wherein the method comprises selecting the position for the middle virtual loudspeaker based on the position of the listener, and selecting the position for the middle virtual loudspeaker based on the position of the listener comprises: i) obtaining listener information indicating a coordinate of the listener (e.g., an x-coordinate); ii) obtaining midpoint information indicating a coordinate (e.g., an x-coordinate) of a midpoint between a first point (e.g., a first edge point of an extent associated with the audio element) associated with the audio element and a second point (e.g., a second edge point of the extent) associated with the audio element; and iii) selecting the position of the middle virtual loudspeaker based on the midpoint information and the listener information.
A19. The method of embodiment A18, wherein selecting the position of the middle virtual loudspeaker based on the midpoint information and the listener information comprises: i) determining a coordinate of an anchor point; and ii) selecting the position of the middle virtual loudspeaker based on the midpoint information and anchor information indicating the determined coordinate of the anchor point.
A20. The method of embodiment A19, wherein: i) the midpoint information comprises a midpoint value, MP, specifying the coordinate of the midpoint, ii) the anchor information comprises an anchor value, A, specifying the coordinate of the anchor point, and iii) selecting the position of the middle virtual loudspeaker based on the midpoint information and anchor information comprises calculating a coordinate value, M, for the middle speaker using MP and A.
A21. The method of embodiment A20, wherein the anchor value, A, is dependent on the indicated coordinate of the listener.
A22. The method of embodiment A21, wherein A=L, where L is the indicated coordinate of the listener (as shown in FIG. 5 and FIG. 6 that the coordinate system can be defined relative to the extent so that the extent extends along the x-axis).
A23. The method of embodiment A20, A21, or A22, wherein calculating M using MP and A comprises calculating M=α*λ+(1−α)*MP, where α is a factor dependent on the indicated coordinate of the listener.
A24. The method of any one of embodiments A18-A23, wherein the listener information further indicates a second coordinate (e.g., a y-coordinate) of the listener, the midpoint information further indicates a second coordinate (e.g., a y-coordinate) of the midpoint, selecting the position of the middle virtual loudspeaker based on the midpoint information and the listener information further comprises determining a second coordinate for the middle virtual loudspeaker based on the second coordinate of the listener and the second coordinate of the midpoint.
A25. The method of any one of embodiments A10 or A18-A24, wherein a first virtual loudspeaker is positioned at the first point and a second virtual loudspeaker is positioned at the second point; and the method further comprises using information identifying the positions of the virtual loudspeakers to render the audio element.
A26. The method of any one of embodiments A1-A25, further comprising: based on the position of the middle virtual loudspeaker, generating a middle virtual loudspeaker signal for the middle virtual loudspeaker; and using the middle virtual loudspeaker signal to render the audio element (e.g., generate an output signal using the middle virtual loudspeaker signal).
B1. A computer program comprising instructions which when executed by processing circuitry of an audio renderer causes the audio renderer to perform the method of any one of the above embodiments.
B2. A carrier containing the computer program wherein the carrier is one of an electronic signal, an optical signal, a radio signal, and a computer readable storage medium.
C1. An audio rendering apparatus that is configured to perform the method of any one of the above embodiments.
C2. The audio rendering apparatus of embodiment C1, wherein the audio rendering apparatus comprises memory and processing circuitry coupled to the memory.

While various embodiments are described herein, it should be understood that they have been presented by way of example only, and not limitation. Thus, the breadth and scope of this disclosure should not be limited by any of the above described exemplary embodiments. Moreover, any combination of the above-described objects in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] MPEG-H 3D Audio, Clause 8.4.4.7: “Spreading”
[2] MPEG-H 3D Audio, Clause 18.1: “Element Metadata Preprocessing” [3]
[3] MPEG-H 3D Audio, Clause 18.11: “Diffuseness Rendering”
[4] EBU ADM Renderer Tech 3388, Clause 7.3.6: “Divergence” [5] EBU ADM Renderer Tech 3388, Clause 7.4: “Decorrelation Filters”
[6] EBU ADM Renderer Tech 3388, Clause 7.3.7: “Extent Panner”
[7] Efficient HRTF-based Spatial Audio for Area and Volumetric Sources “, IEEE Transactions on Visualization and Computer Graphics 22 (4): 1-1· January 2016
[8] Patent Publication WO2020144062, “Efficient spatially-heterogeneous audio elements for Virtual Reality.”
[9] Patent Publication WO2021180820, “Rendering of Audio Objects with a Complex Shape.”

1. A method for rendering an audio element, wherein the audio element has an extent and is represented using a set of virtual loudspeakers comprising a middle virtual loudspeaker, the method comprising:
based on a position of a listener, selecting a position for the middle virtual loudspeaker and/or calculating an attenuation factor for the middle virtual loudspeaker.

2. The method of claim 1, wherein the method comprises selecting the position for the middle virtual loudspeaker based on the position of the listener, and selecting the position for the middle virtual loudspeaker based on the position of the listener comprises:
determining a first angle based on the position of the listener and a position of i) a first edge point of the audio element or of an extent that was determined based on the extent of the audio element or ii) a first virtual loudspeaker;
determining a second angle based on the position of the listener and a position of i) a second edge point of the audio element or of the extent or ii) a second virtual loudspeaker; and
calculating a first coordinate, Mx, for the middle virtual loudspeaker using the first angle and the second angle, wherein the selected position for the middle virtual loudspeaker is specified at least partly by the calculated first coordinate.

3-9. (canceled)

10. The method of claim 1, wherein the method comprises selecting the position for the middle virtual loudspeaker based on the position of the listener, and selecting the position for the middle virtual loudspeaker based on the position of the listener comprises:
selecting a position point on a first straight line 1) between a first point of the audio element or of an extent that was determined based on the extent of the audio element and a second point of the audio element or of the extent or 2) between a first virtual speaker and a second virtual speaker, such that:
the angle between i) a second straight line running from the position of the listener to the first point or the first virtual speaker and ii) a third straight line running from the position of the listener to the selected position point on the first straight line is equal to the angle between i) a fourth straight line running from the position of the listener to the second point or to the second virtual loudspeaker and ii) the third straight line.

11. The method of claim 10, wherein selecting the position point comprises calculating a coordinate, M, of the position point by calculating:
$$M = ( v * Re + w * Le ) / ( v + w ) ,$$
v is the length of the second straight line,
w is the length of the third straight line,
Re is a coordinate of the first point or first virtual speaker, and
Le is a coordinate of the second point or second virtual speaker.

12. The method of claim 10, further comprising positioning the middle virtual loudspeaker at the selected position point.

13. The method of claim 1, wherein the method comprises calculating an attenuation factor for the middle virtual loudspeaker based on the position of the listener, and calculating the attenuation factor for the middle virtual loudspeaker based on the position of the listener comprises:
determining a first angle based on the position of the listener and i) a position of a first edge point of the audio element or of an extent that was determined based on the extent of the audio element or ii) a position of a first virtual loudspeaker;
determining a second angle based on the position of the listener and a position of a second edge point of the audio element or of the extent or ii) a position of a second virtual loudspeaker; and
calculating ε=sin (λ)/sin (β) or ε=sin (β)/sin (λ), where λ is the first angle, β is the second angle, and ε is the attenuation factor.

14. The method of claim 13, further comprising modifying a signal, X, for the middle virtual loudspeaker to produce a modified middle virtual loudspeaker signal, X′, such that X′=ε*X, and using the modified middle virtual loudspeaker signal to render the audio element.

15-17. (canceled)

18. The method of claim 1, wherein the method comprises selecting the position for the middle virtual loudspeaker based on the position of the listener, and selecting the position for the middle virtual loudspeaker based on the position of the listener comprises:
i) obtaining listener information indicating a coordinate of the listener;
ii) obtaining midpoint information indicating a coordinate of a midpoint between a first point associated with the audio element and a second point associated with the audio element; and
iii) selecting the position of the middle virtual loudspeaker based on the midpoint information and the listener information.

19. The method of claim 18, wherein selecting the position of the middle virtual loudspeaker based on the midpoint information and the listener information comprises:
i) determining a coordinate of an anchor point; and
ii) selecting the position of the middle virtual loudspeaker based on the midpoint information and anchor information indicating the determined coordinate of the anchor point.

20. The method of claim 19, wherein:
i) the midpoint information comprises a midpoint value, MP, specifying the coordinate of the midpoint, ii) the anchor information comprises an anchor value, A, specifying the coordinate of the anchor point, and iii) selecting the position of the middle virtual loudspeaker based on the midpoint information and anchor information comprises calculating a coordinate value, M, for the middle speaker using MP and A.

21. The method of claim 20, wherein the anchor value, A, is dependent on the indicated coordinate of the listener.

22. The method of claim 21, wherein A=L, where L is the indicated coordinate of the listener.

23. The method of claim 20, wherein calculating M using MP and A comprises calculating M=α*λ+(1−α)*MP, where α is a factor dependent on the indicated coordinate of the listener.

24-25. (canceled)

26. The method of claim 1, further comprising:
based on the position of the middle virtual loudspeaker, generating a middle virtual loudspeaker signal for the middle virtual loudspeaker; and
using the middle virtual loudspeaker signal to render the audio element.

27-28. (canceled)

29. An audio rendering apparatus for rendering an audio element, wherein the audio element has an extent and is represented using a set of virtual loudspeakers comprising a middle virtual loudspeaker, the audio rendering apparatus being configured to:
based on a position of a listener, select a position for the middle virtual loudspeaker and/or calculating an attenuation factor for the middle virtual loudspeaker.

30. The audio rendering apparatus of claim 29, wherein the audio rendering apparatus is configured to select the position for the middle virtual loudspeaker based on the position of the listener by:
determining a first angle based on the position of the listener and a position of i) a first edge point of the audio element or of an extent that was determined based on the extent of the audio element or ii) a first virtual loudspeaker;
determining a second angle based on the position of the listener and a position of i) a second edge point of the audio element or of the extent or ii) a second virtual loudspeaker; and
calculating a first coordinate, Mx, for the middle virtual loudspeaker using the first angle and the second angle, wherein the selected position for the middle virtual loudspeaker is specified at least partly by the calculated first coordinate.

31-37. (canceled)

38. The audio rendering apparatus of claim 29, wherein the audio rendering apparatus is configured to select the position for the middle virtual loudspeaker based on the position of the listener by:
selecting a position point on a first straight line 1) between a first point of the audio element or of an extent that was determined based on the extent of the audio element and a second point of the audio element or of the extent or 2) between a first virtual speaker and a second virtual speaker, such that:
the angle between i) a second straight line running from the position of the listener to the first point or the first virtual speaker and ii) a third straight line running from the position of the listener to the selected position point on the first straight line is equal to the angle between i) a fourth straight line running from the position of the listener to the second point or to the second virtual loudspeaker and ii) the third straight line.

39. The audio rendering apparatus of claim 38, wherein selecting the position point comprises calculating a coordinate, M, of the position point by calculating:
$$M = ( v * Re + w * Le ) / ( v + w ) ,$$
v is the length of the second straight line,
w is the length of the third straight line,
Re is a coordinate of the first point or first virtual speaker, and
Le is a coordinate of the second point or second virtual speaker.

40. The audio rendering apparatus of claim 38, wherein the audio rendering apparatus is further configured to position the middle virtual loudspeaker at the selected position point.

41. The audio rendering apparatus of claim 29, wherein the audio rendering apparatus is configured to calculate the attenuation factor for the middle virtual loudspeaker based on the position of the listener by:
determining a first angle based on the position of the listener and i) a position of a first edge point of the audio element or of an extent that was determined based on the extent of the audio element or ii) a position of a first virtual loudspeaker;
determining a second angle based on the position of the listener and i) a position of a second edge point of the audio element or of the extent or ii) a position of a second virtual loudspeaker; and
calculating ε=sin (λ)/sin (β) or ¿=sin (β)/sin (λ), where λ is the first angle, β is the second angle, and ε is the attenuation factor.

42. The audio rendering apparatus of claim 41, wherein the audio rendering apparatus is further configured to modify a signal, X, for the middle virtual loudspeaker to produce a modified middle virtual loudspeaker signal, X′, such that X′=ε*X, and using the modified middle virtual loudspeaker signal to render the audio element.

43-45. (canceled)

46. The audio rendering apparatus of claim 29, wherein the audio rendering apparatus is configured to select the position for the middle virtual loudspeaker based on the position of the listener by:
i) obtaining listener information indicating a coordinate of the listener;
ii) obtaining midpoint information indicating a coordinate of a midpoint between a first point associated with the audio element and a second point associated with the audio element; and
iii) selecting the position of the middle virtual loudspeaker based on the midpoint information and the listener information.

47. The audio rendering apparatus of claim 46, wherein selecting the position of the middle virtual loudspeaker based on the midpoint information and the listener information comprises:
i) determining a coordinate of an anchor point; and
ii) selecting the position of the middle virtual loudspeaker based on the midpoint information and anchor information indicating the determined coordinate of the anchor point.

48. The audio rendering apparatus of claim 47, wherein:
i) the midpoint information comprises a midpoint value, MP, specifying the coordinate of the midpoint, ii) the anchor information comprises an anchor value, A, specifying the coordinate of the anchor point, and iii) selecting the position of the middle virtual loudspeaker based on the midpoint information and anchor information comprises calculating a coordinate value, M, for the middle speaker using MP and A.

49. The audio rendering apparatus of claim 48, wherein the anchor value, A, is dependent on the indicated coordinate of the listener.

50-53. (canceled)

54. The audio rendering apparatus of claim 29, further being configured to:
based on the position of the middle virtual loudspeaker, generate a middle virtual loudspeaker signal for the middle virtual loudspeaker; and
use the middle virtual loudspeaker signal to render the audio element.
